(19) United States
(12) Patent Application Publication
(10) Pub. No.: US 2005/0249101 A1
(43) Pub. Date: Nov. 10, 2005

(54) Disc loading apparatus

(76) Inventor: Tomoshi Tokunaga, Zama-shi (JP)

Correspondence Address: NATH & ASSOCIATES, PLLC, Sixth Floor, 1030 15th Street, N.W., Washington, DC, 20005, US

(21) Appl. No.: 11/116,337

(22) Filed: Apr. 28, 2005

(30) Foreign Application Priority Data
May 6, 2004 (JP) P2004-137106

(51) Int. Cl. G11B 17/30

(52) U.S. Cl. 369/217; 369/231

(57) ABSTRACT

The driving state in a loading path is controlled in accordance with a loading operation of a placing member on which a disc-like medium is placed. According to a disc loading apparatus, a placing member on which a disc-like medium is placed is loaded or ejected into or from a disc loading device by a drive unit. The disc loading apparatus comprises a position detection unit which optically detects a position of the placing member in a region of movement concerting at least a portion of the loading path, and a drive profile control unit which changes a drive profile of a drive unit based on a position detection signal from the position detection unit.

### BACKGROUND OF THE INVENTION

The present invention relates to a disc loading apparatus which loads or ejects a disc-like medium used for recording and reproducing information in a disc drive apparatus, into or from a drive body.

Generally, in a disc drive apparatus, a medium including a bare disc or a disc accommodated in a cartridge is placed on a tray, and this tray is loaded or ejected into or from a drive body.

With reference to a conventional disc drive apparatus (optical disc recording and reproducing device) shown in FIGS. 1 and 2, an explanation will be given on how to place a cartridge on a tray, a cartridge-holding mechanism, and operations of loading and ejecting of a tray.

In FIG. 1, the reference numeral 201 denotes a body of an optical disc recording and reproducing device, 204 a tray, on which a cartridge and a bare optical disc are placed, and 100 a cartridge, in which an optical disc is accommodated.

A cartridge-placing surface 233 of the tray 204 is provided in the center thereof with two large and small recesses that are provided concentrically. A large-diameter recess defines a large-diameter disc-placing portion 231 and a small-diameter recess defines a small-diameter disc-placing portion 232, both recesses being prepared for use in accordance with an outside diameter of a disc placed in the optical disc recording and reproducing device 201.

In addition, the tray 204 is formed with a front wall 234, a left wall 235, and a right wall 236, which are slightly larger than outside dimension of the cartridge 100 and formed perpendicular to the cartridge-placing surface 233.

As shown in FIG. 2, a cartridge preloading member 237 is provided on an interior part of the tray 204 to be movable in a front/rear direction, and constructed to be held in a preloaded state on a front part of the tray 204.

The tray 204 is provided at its back surface with a rack gear 288 which engages with a final-stage drive gear of a loading gear system 281. The loading gear system 281 is driven by a loading motor 280 provided on a front side of a mechanical chassis 201a.

Thus, the tray 204 can load and eject by switching a rotational direction of the loading motor 280.

A traverse base 266 holds thereon a spindle motor 282 that holds and rotates a disc, an optical pickup 283 that reads and writes information from and onto a disc, a traverse motor 284 that moves the optical pickup 283 radially of a disc, and a lead screw 297.

A rear end of the traverse base 266 is turnably held on the mechanical chassis 201a by a torsion spring and a front end thereof is preloaded downward with a light load.

Two slit holes are provided right and left at the front end of the traverse base 266 to engage with a cam lever 285 that is inserted thereinto to turn about a rotating shaft 292 provided on a bottom surface of the mechanical chassis 201a. The traverse base 266 is vertically driven upon turning of the cam lever 285.

Provided on the traverse base 266 are two alignment pins 214 that engage with positioning holes of the cartridge 100 to keep a clearance between a disc held on the spindle motor 282 and the cartridge 100 to position the cartridge 100 where it does no contact with the disc.

A disc-state detection switch 215 is provided near the alignment pins 214. A plurality of detection switches mounted on a printed board are provided integrally with the traverse base 266 to distinguish a state of engagement with detection holes of the cartridge 100, thereby detecting a state of approval or denial of writing on a disc accommodated in the cartridge 100, front and back surfaces of a disc, and the recording capacity of a disc.

An upper base 228 as an upper lid is provided on the mechanical chassis 201a. Provided on the upper base 228 are a clamper 210 that fixes a disc to the spindle motor 282, clamp arms 212 that hold and make the clamper 210 vertically detachable from the spindle motor 282, and cartridge holding springs 229 that restrict vibrations of the cartridge 100 at the time of loading.

The cartridge 100 is fixed to the tray 204 by the downward biasing force of the cartridge holding springs 229. The biasing force of the cartridge holding springs 229 functions to urge the cartridge 100 against the tray 204 and urge the tray 204 against the mechanical chassis 201a from immediately after the beginning of loading to the completion of loading to eliminate looseness generated among the cartridge 100, the tray 204, and the mechanical chassis 201a, thus reducing vibrations and noise that are generated at the time of loading and rotation of a disc.

An operation of the optical disc recording and reproducing device 201 configured in the above manner will be described taking the case of reproducing a disc accommodated in the cartridge 100.

When placing the cartridge 100 on the tray 204 surrounded by the front wall 234, the left wall 235, and the right wall 236, placement of the cartridge 100 on the tray 204 is completed by sliding the cartridge 100 obliquely downward from forwardly upward of the tray 204 while causing a rear end of the cartridge 100 to push the cartridge preloading member 237 into the further inner part of the tray 204, and finally placing a front end of the cartridge 100 on the cartridge-placing surface 233 in a manner to bring the front end of the cartridge 100 into contact with an inner side of the front wall 234.

At this time, the front end of the cartridge 100 is pushed against the inner side of the front wall 234 by the cartridge preloading member 237 and the cartridge 100 is positioned relative to the tray 204 without looseness in back and forth and right to left directions.

The tray 204, on which the cartridge 100 is placed, is automatically loaded inside the optical disc recording and reproducing device 201 by a drive force of the loading motor 280.

Until loading of the tray 204 is completed, the spindle motor 282, the traverse motor 284, and the optical pickup 283, which are held on the traverse base 266, escape below a loading path of the tray 204 in order to avoid interference with the tray 204, the cartridge 100, and the disc.

Immediately before loading of the tray 204 is completed, a clamp-arm driving projection provided on the tray 204 pushes up one side of the clamp arm 212 that are turnably provided on the upper base 228 by hinges, and lowers the other side of the clamp arm 212, on which the clamper 210 is held. As a result, the clamper 210 is lowered to a position where a disc can be clamped.

When loading of the cartridge 100 placed on the tray 204 is completed after the clamper 210 is lowered, engagement between the tray 204 and the rack gear 288 is released, a drive force by the drive gear is cut off from the tray 204, and only the rack gear 288 is driven rearward relative to the tray 204. The force that drives the rack gear 288 rearward is transmitted to the cam lever 285 as torque of rotation, so that the traverse base 266 ascends along an inclination of the cam lever 285.

As the traverse base 266 ascends, the two alignment pins 214 provided integrally on the traverse base 266 are inserted into two positioning holes provided on the front part of the cartridge 100.

The cartridge 100 is caused to be positionally offset relative to the spindle motor 282 at the time of loading due to looseness between the tray 204 and the mechanical chassis 201a and looseness between the cartridge 100 and the tray 204. When a disc rotates while the cartridge 100 is offset relative to the spindle motor 282, noise is generated due to contact between an outer periphery of the disc and the inner wall of the cartridge 100. When there is a large positional offset, contact acts as resistance to release the clamped state of a disc which may damage the disc inside the cartridge 100.

The alignment pins 214 are inserted into the positioning holes of the cartridge 100 whereby the positional offset of the cartridge 100 relative to the spindle motor 282 is improved and an adequate clearance is ensured between the cartridge 100 and a disc.

Almost simultaneously with insertion of the alignment pins 214 into the positioning holes of the cartridge 100, the disc-state detection switch 215 is also inserted into the state detection hole of the cartridge 100.

Unlike the alignment pins 214, a large clearance is ensured between the state detection hole and the disc-state detection switch 215, so that the insertion is guaranteed with a margin with respect to detection of a state of the cartridge 100 even when the cartridge 100 is positionally offset.

With the insertion of the alignment pins 214 and the disc-state detection switch 215 into the cartridge 100, a center cone is inserted into a center hole of a disc accommodated in the cartridge 100 and the disc floats in a space inside the cartridge 100 while the traverse base 266 ascends.

As the disc floats, the clamper 210 standing by in a clamp position engages with the center cone and clamping of the disc is completed.

However, the conventional disc drive apparatus (optical disc recording and reproducing device) described above involves the following problem.

In the case of a disc loading apparatus which can handle both a bare disc and a disc accommodated in a cartridge as a medium, a load generated when a shutter of the cartridge is opened and closed, and a load generated for loading the cartridge into the drive body against a load of the cartridge are excessively large. Therefore, a driving system including gear ratio is generally designed while giving a high priority to the cartridge.

As a result, a large driving torque is required, and if a gear ratio that is just suitable when the cartridge is to be loaded into, the loading speed of the tray or the like when there is a bare disc or there is no medium, the loading speed becomes excessively fast, and a noise is generated at the time of loading. Further, if the speed and the noise of a tray are varied from one medium to another, the entire integrity of the disc drive apparatus is deteriorated.

When a trouble such as miss-placement of the cartridge is generated and the tray stops at midpoint in the loading operation, an operation mode is generally shifted to a fail-safe operation mode after a predetermined time (longer than time required for a predetermined loading operation) is elapsed.

Thus, it takes time until troubleshooting suitable for a trouble is carried out, and this makes the user feel anxious.

### SUMMARY OF THE INVENTION

The present invention has been achieved with a view to such problems, and an object of the invention is to provide a disc loading apparatus that can control a driving state in a loading path in accordance with a loading operation of a placing member on which a disc-like medium is placed.

The present invention solves the problems of the conventional technique, and a first aspect of the invention provides a disc loading apparatus comprising a disc loading device, into or from which a placing member with a disc-like medium placed thereon is loaded or ejected by a drive unit, a position detection unit which optically detects a position of a region of movement of the placing member concerning at least a portion of a loading path with a loading operation of the placing member, and a drive profile control unit which changes a drive profile of the drive unit based on a position detection signal from the position detection unit.

A second aspect of the invention provides a disc loading apparatus comprising a disc loading device, into or from which a placing member on which a cartridge accommodating a disc-like medium therein is placed is loaded or ejected by a drive unit, a position detection unit which optically detects a position of a region of movement of the placing member concerning at least a portion of a loading path with a loading operation of the placing member, and a drive profile control unit which changes a drive profile of the drive unit based on a position detection signal from the position detection unit.

A third aspect of the invention provides the disc loading apparatus according to the second aspect, further comprising a medium type detection unit which optically detects types of a medium placed on the placing member based on whether a detection hole for detecting a medium provided on the placing member is shielded at the time of a loading operation of the placing member, wherein the drive profile control unit changes the drive profile based on a position detection signal from the position detection unit and a medium type detecting signal from the medium type detection unit.

A fourth aspect of the invention provides the disc loading apparatus according to the first aspect, further comprising a temperature measuring unit which measures temperature in the disc loading device, wherein the drive profile control unit changes the drive profile based on temperature measured by the temperature measuring unit.

A fifth aspect of the invention provides the disc loading apparatus according to the second aspect, further comprising a temperature measuring unit which measures temperature in the disc loading device, wherein the drive profile control unit changes the drive profile based on temperature measured by the temperature measuring unit.

A sixth aspect of the invention provides the disc loading apparatus according to the third aspect, further comprising a temperature measuring unit which measures temperature in the disc loading device, wherein the drive profile control unit changes the drive profile based on temperature measured by the temperature measuring unit.

A seventh aspect of the invention provides the disc loading apparatus according to the first aspect, wherein the drive profile control unit monitors a generation state of a position detection signal from the position detection unit, and changes the drive profile when abnormality of the position detection signal is generated.

A eighth aspect of the invention provides the disc loading apparatus according to the second aspect, wherein the drive profile control unit monitors a generation state of a position detection signal from the position detection unit, and changes the drive profile when abnormality of the position detection signal is generated.

A ninth aspect of the invention provides the disc loading apparatus according to the third aspect, wherein the drive profile control unit monitors a generation state of a position detection signal from the position detection unit, and changes the drive profile when abnormality of the position detection signal is generated.

### BRIEF DESCRIPTION OF THE DRAWINGS

The above and further objects and novel features of the present invention will more fully appear from the following detailed description when the same is read in conjunction with the accompanying drawings, in which:

FIG. 1 is a perspective view showing a conventional example as a whole;

FIG. 2 is an exploded, perspective view showing the conventional example as a whole;

FIG. 3 is a perspective view showing an embodiment of a disc loading apparatus according to the invention;

FIG. 4 is a perspective view showing a state, in which a top cover is removed;

FIG. 5 is a perspective view showing the arrangement of a slide cam, an optical sensor, and light emitting diodes;

FIG. 6 is a perspective view showing the arrangement of the light receiving diodes;

FIG. 7 is a perspective view showing a tray;

FIG. 8 is a perspective view showing the tray as viewed from a back surface thereof;

FIG. 9 is a plan view showing the arrangement of detection holes on the tray;

FIG. 10 is a plan view showing the relationship between a cartridge and the detection holes on the tray;

FIG. 11 is a plan view showing the relationship between a 12-cm disc and the detection holes on the tray;

FIG. 12 is a plan view showing the relationship between an 8-cm disc and the detection holes on the tray;

FIG. 13 is a block diagram showing a detection unit;

FIG. 14 shows an internal table indicating reference shield patterns;

FIG. 15 is a perspective view of a traverse base;

FIG. 16 is an enlarged perspective view of an alignment pin;

FIG. 17 is a perspective view of a tray when a loading operation is completed;

FIG. 18 is a block diagram of a control circuit;

FIGS. 19A & 19B are explanatory diagrams of PWM drive voltage and PWM drive current;

FIG. 20 is an explanatory diagram of a drive profile in the loading operation; and

FIG. 21 is an explanatory diagram of the drive profile in the ejecting operation.

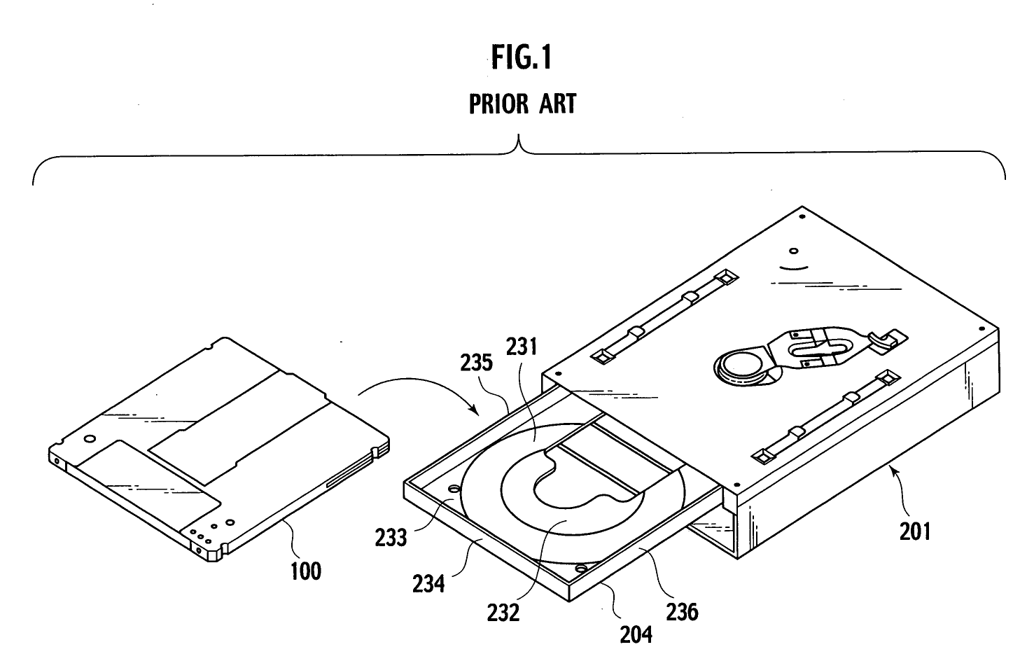

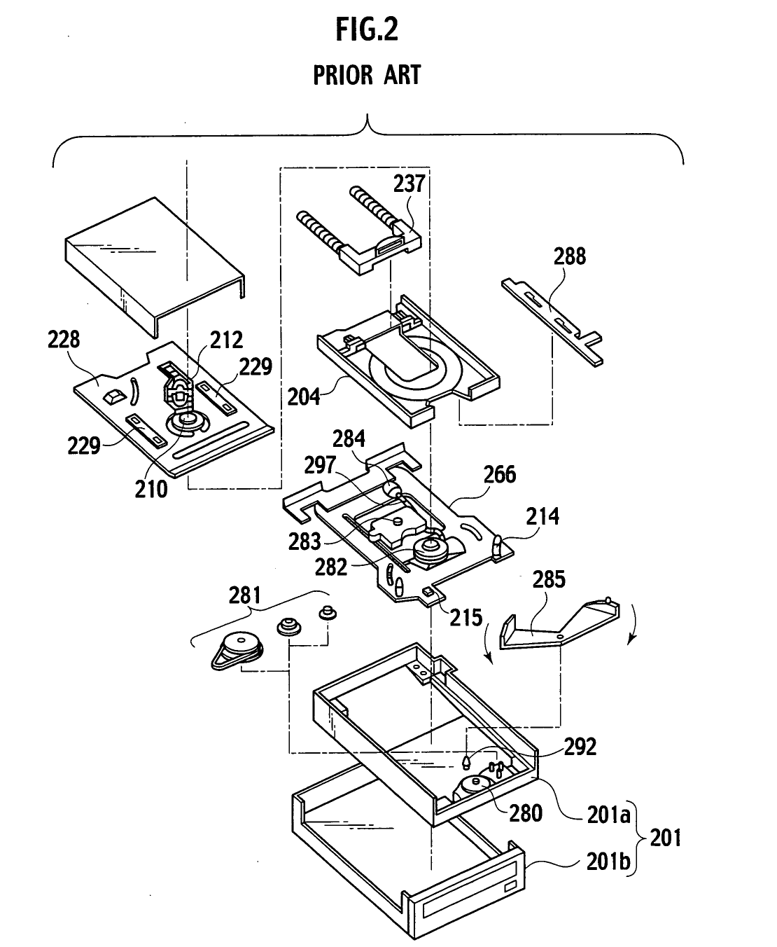

### DETAILED DESCRIPTIONS

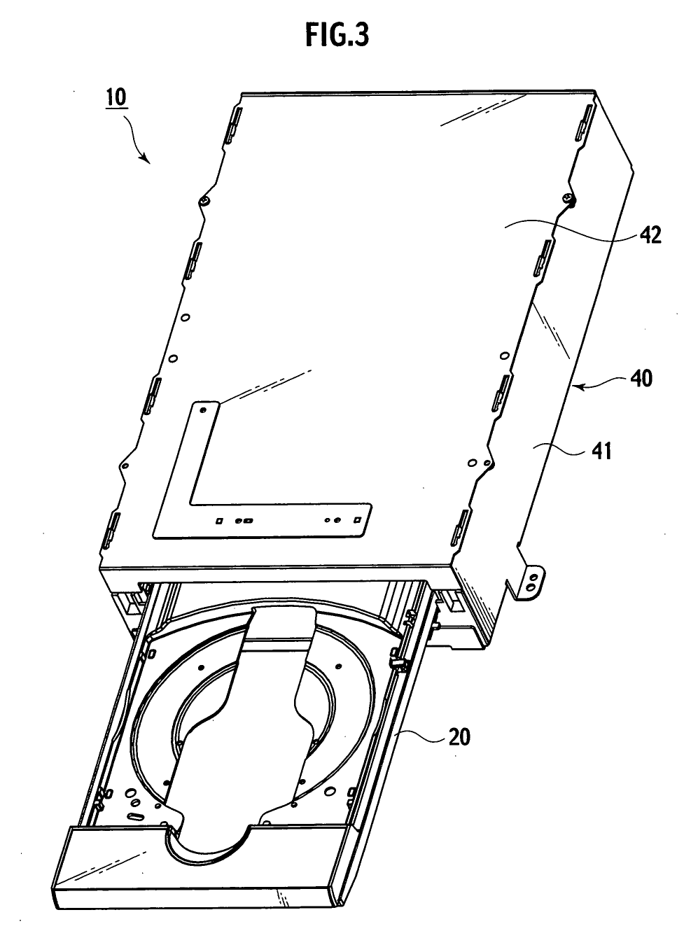

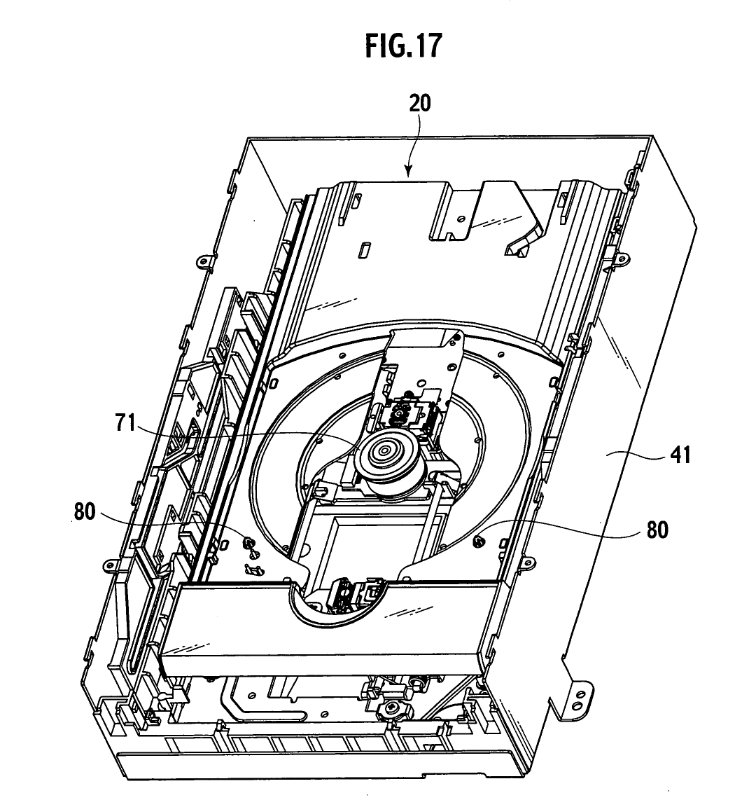

An embodiment of the present invention will be explained with reference to FIGS. 3 to 21.

FIG. 3 is a perspective view showing an embodiment of a disc loading apparatus according to the present invention. The disc loading apparatus (disc drive apparatus) 10 includes a tray (placing member) 20 on which a disc-like medium is placed, and a disc loading device (drive body) 40 into or from which the tray 20 is loaded or ejected by a loading motor.

The disc loading apparatus (disc drive apparatus) 10 is not of a type that a traverse base provided with a spindle motor is moved up and down relative to a medium held in a predetermined height to have the spindle motor loaded on a disc, but of a type that a medium placed on the tray 20 is moved up and down near completion of loading to have a disc loaded on a spindle motor.

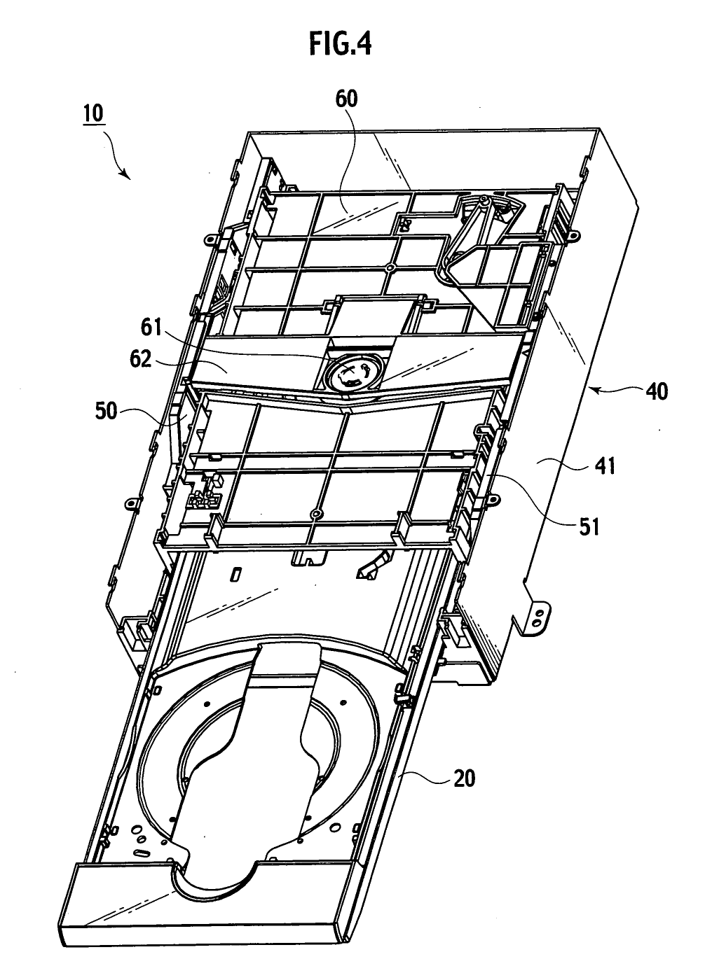

The disc loading device (drive body) 40 is configured such that a mechanical chassis 41 is covered by a top cover 42. FIG. 4 shows a state, in which the top cover 42 is removed, and a tray holder 60 is arranged in the disc loading device 40 to support the tray 20 allowing horizontal movement of the tray 20 in a front/rear direction.

A clamper 61 that fixes a disc to a spindle motor is supported on the tray holder 60 by a clamp arm 62 to be made vertically detachable from the spindle motor.

Slide cams 50 and 51 are provided on both left and right side walls of the disc loading device 40 to be horizontally movable in the front/rear direction. In addition, the left and right slide cams 50 and 51 are mounted on both ends of a connection arm (not shown) that is provided in the center of a bottom of the mechanical chassis 41 to be able to swing around a pivot.

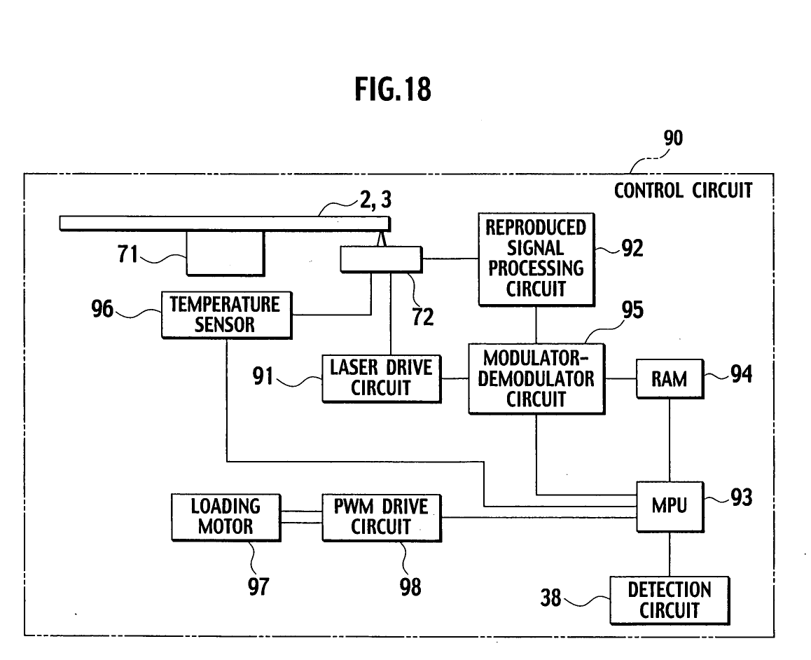

A right slide cam 51 is provided at its lower portion with a rack gear (not shown). The rack gear meshes with a pinion gear which is driven by the loading motor (97: see FIG. 18) provided at a right lower portion of the disc loading device 40.

Therefore, when the pinion gear is driven to move the right slide cam 51 horizontally rearward, the left slide cam 50 connected thereto by the connection arm is moved horizontally forward. In addition, the loading motor is switched in a rotation direction to reverse moving directions of the left and right slide cams 50 and 51.

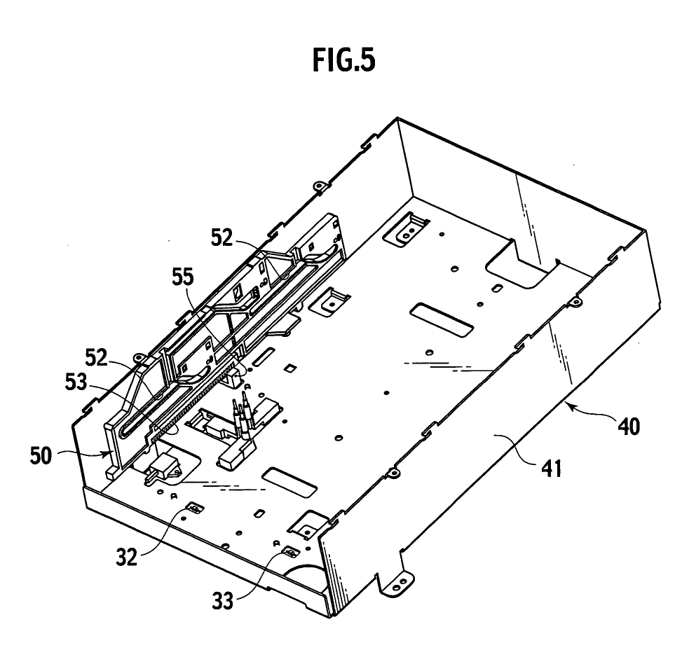

The tray holder 60 is supported to be vertically movable relative to the mechanical chassis 41. In addition, projections (not shown) provided on both left and right side walls of the tray holder 60 are in engagement with grooved actuation cams that are formed on the left and right slide cams 50 and 51. FIG. 5 shows the left slide cam 50 and the actuation cams 52 formed thereon.

As shown in FIG. 5, each of the actuation cams 52 on the left slide cam 50 is formed with a downwardly inclined portion that is contiguous to a horizontal portion extended rearward from the front side. On the other hand, the actuation cams on the right slide cam 51 is formed with a downwardly inclined portion that is contiguous to a horizontal portion extended the front side from a rear part.

Therefore, when the pinion gear is driven to move the right slide cam 51 horizontally rearward and to move the left slide cam 50 horizontally forward, the tray holder 60 is held in a high position on the way along the movement path just till beyond midway of the path. Then, the tray holder 60 descends near a terminal end of the movement path to be switched to a low position to be held there.

Furthermore, when the loading motor is switched in the rotation direction so that the right slide cam 51 moves horizontally forward and the left slide cam 50 moves horizontally rearward, the tray holder 60 ascends to a high position from a low position near a starting end of the movement path and thereafter it is held in a high position.

The high position of the tray holder 60 is a height at which loading and ejecting of a medium are performed, while the low position of the tray holder 60 is a height at which a medium is loaded on a spindle motor.

As shown in FIG. 5, the left slide cam 50 is provided with a ladder portion 53 that includes a plurality of slits formed with a uniform space along a moving direction of the slide cam 50. Optical sensors 55 are mounted on a printed board to interpose the ladder portion 53 from left and right, and fixed to the bottom of the mechanical chassis 41.

Therefore, when the slide cam 50 moves, the optical sensor 55 detects light passing through the slit of the ladder portion 53, whereby a pulsed output is obtained. A counter (not shown) counts the pulsed output, thereby enabling accurate recognition of a present position of the slide cam 50 in a region of movement in real time.

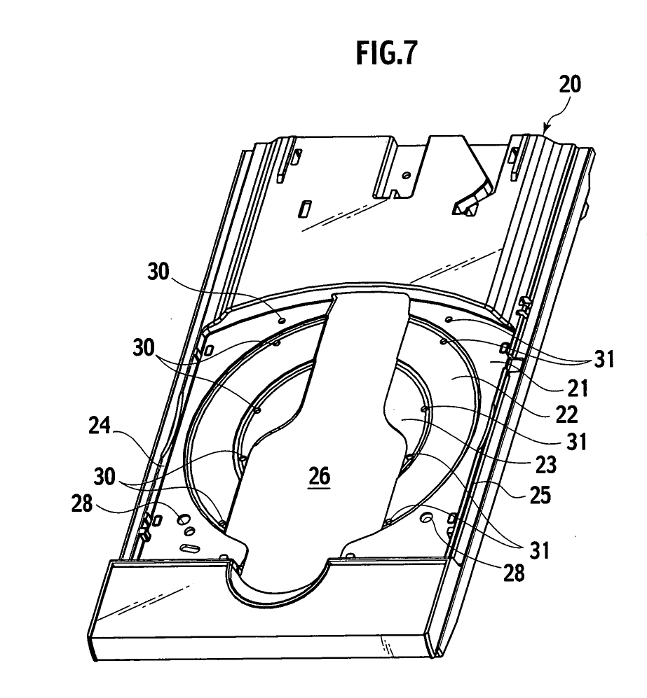

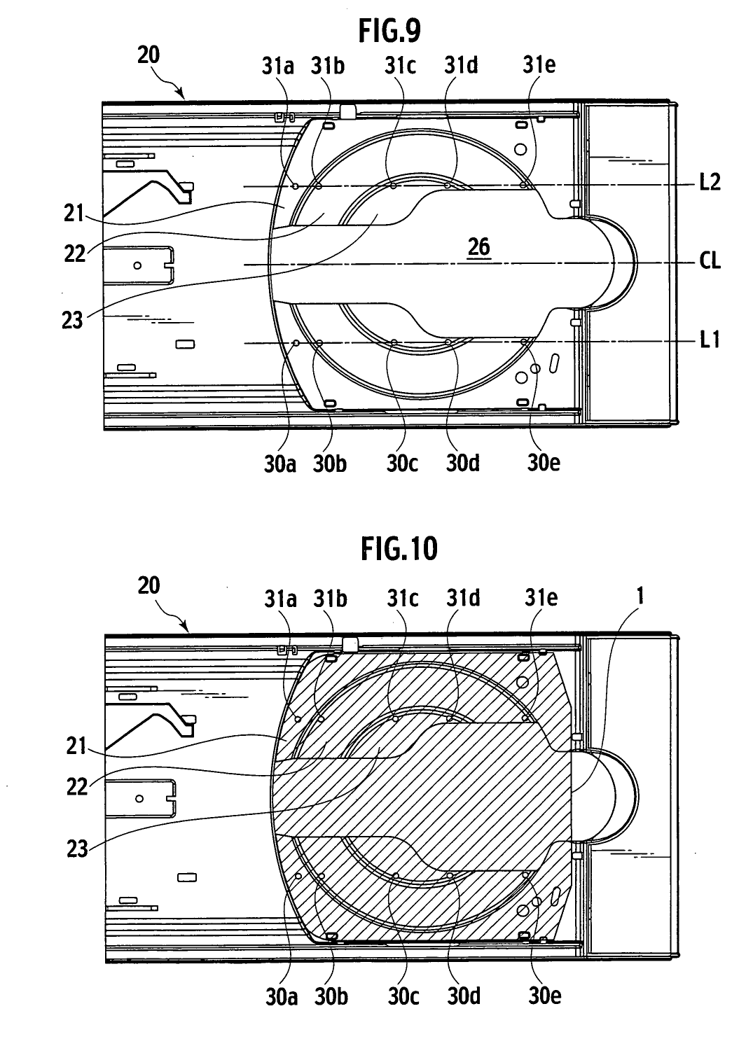

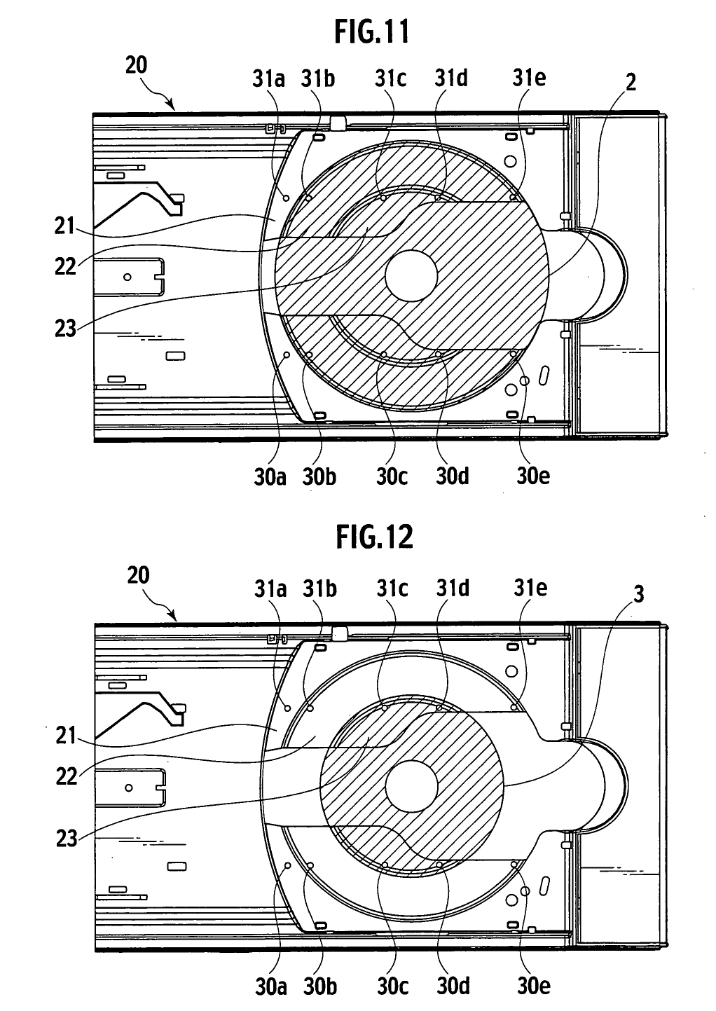

FIG. 7 is a perspective view showing the tray 20, and FIG. 8 is a perspective view showing the tray 20 as viewed from the back surface thereof. The tray 20 is configured to be able to place thereon a cartridge 1 (see FIG. 10) that accommodates therein a disc, and bare discs 2 (see FIG. 11) and 3 (see FIG. 12) of two large and small sizes, as a medium.

As shown in FIG. 7, the tray 20 includes a cartridge-placing surface 21 to place thereon the cartridge 1, a large-diameter disc-placing surface 22 to place thereon a large-diameter (for example, 12 cm) disc 2, and a small-diameter disc-placing surface 23 to place thereon a small-diameter (for example, 8 cm) disc 3, such that central positions of the discs are made coincident vertically with one another.

That is, the cartridge-placing surface 21 on the tray 20 is formed to be a recess having a size to accommodate therein the cartridge 1, in comparison with heights in front and in rear, and a left wall 24 and a right wall 25, which are formed on both left and right sides of the tray 20, function as left and right positioning guides when the cartridge 1 is to be placed on the tray 20.

The large-diameter disc-placing surface 22 and the small-diameter disc-placing surface 23 are arranged concentrically in a central position of a disc accommodated in the cartridge 1 on the cartridge-placing surface 21, the large-diameter disc-placing surface 22 being slightly recessed relative to the cartridge-placing surface 21, and the small-diameter disc-placing surface 23 being slightly recessed relative to the large-diameter disc-placing surface 22.

An opening 26 of a predetermined width to be clear of an optical pickup provided in the disc loading device 40 is formed on the cartridge-placing surface 21, the large-diameter disc-placing surface 22, and the small-diameter disc-placing surface 23 on the tray 20 to extend through central portions thereof and along the front/rear direction, in which the tray 20 moves.

As shown in FIG. 8, a rack gear 27 is provided on a back surface of the tray 20 to mesh with a drive gear that is driven by a loading motor (97: see FIG. 18) provided in a lower portion of the right front side of the disc loading device 40. The tray 20 is configured to make it possible to select loading (carrying-in) and ejecting (carrying-out) upon switching the rotation direction of the loading motor.

In this manner, the pinion gear which drives the right slide cam 51 and the drive gear which drives the tray 20 are driven by the same loading motor (97; see FIG. 18). Thus, the optical sensor 55 detects light which passes through a slit of the lattice portion 53 provided on the left slide cam 50, and a counter counts the obtained pulse output. Accordingly, it is possible to accurately recognize in real time not only the position of the slide cam 50 but also which part in a region of movement the tray 20 is located. Further, a moving speed can be obtained by measuring the time.

As shown in FIGS. 7 to 9, the tray 20 is formed with a plurality of detection holes 30 and 31 for detection of a medium. The detection holes 30 and 31 are arranged symmetrically in the left and right directions on two straight lines L1, L2 that are in parallel to the center line CL on both left and right sides of the opening 26 in the movement direction of the tray 20 to extend on the small-diameter disc-placing surface 23.

That is, the detection holes 30a and 31a are formed on the cartridge-placing surface 21 of the tray 20 to be symmetrical in the left and right directions rearward of the large-diameter disc-placing surface 22.

The detection holes 30b and 31b are formed on the large-diameter disc-placing surface 22 to be symmetrical in the left and right directions rearward of the small-diameter disc-placing surface 23, and the detection holes 30e and 31e are formed on the large-diameter disc-placing surface 22 to be symmetrical in the left and right directions forward of the small-diameter disc-placing surface 23.

All the detection holes 30b, 31b, 30e and 31e are arranged slightly inside of an outer diameter of a recording surface of the large-diameter disc (12-cm disc) 2 placed in a predetermined position on the large-diameter disc-placing surface 22.

The detection holes 30c and 31c are formed in the rear side on the small-diameter disc-placing surface 23 to be symmetrical in the left and right direction, and the detection holes 30d and 31d are formed in the front side on the small-diameter disc-placing surface 23 to be symmetrical in the left and right direction.

All the detection holes 30c, 31c, 30d and 31d are arranged slightly inside of an outer diameter of a recording surface of the small-diameter disc (8-cm disc) 3 placed in a predetermined position on the small-diameter disc-placing surface 23.

As shown in FIG. 5, two light emitting diodes 32 and 33 are provided in the front side of the disc loading device 40 forwardly of the tray holder 60 and symmetrical in the left and right directions and to be positioned just below the straight lines L1, L2, the light emitting diodes being mounted on the printed board to be fixed to the bottom of the mechanical chassis 41.

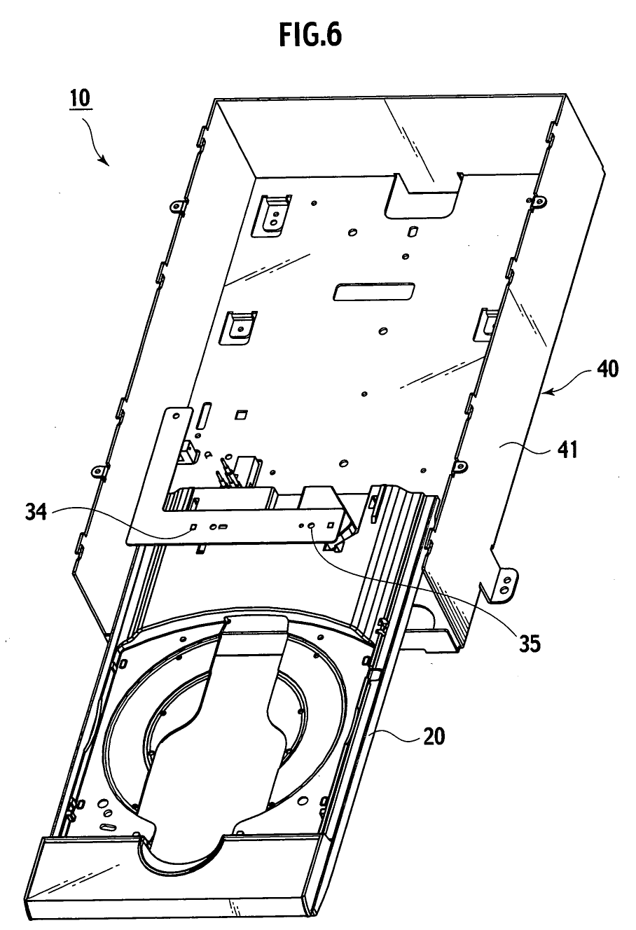

In addition, as shown in FIG. 6, two light receiving diodes 34 and 35 are provided in the forward side of the disc loading device 40 to be symmetrical in the left and right directions and to be positioned just above the light emitting diodes 32 and 33, the light receiving diodes being mounted on the printed board to be fixed to the back surface of the top cover 42.

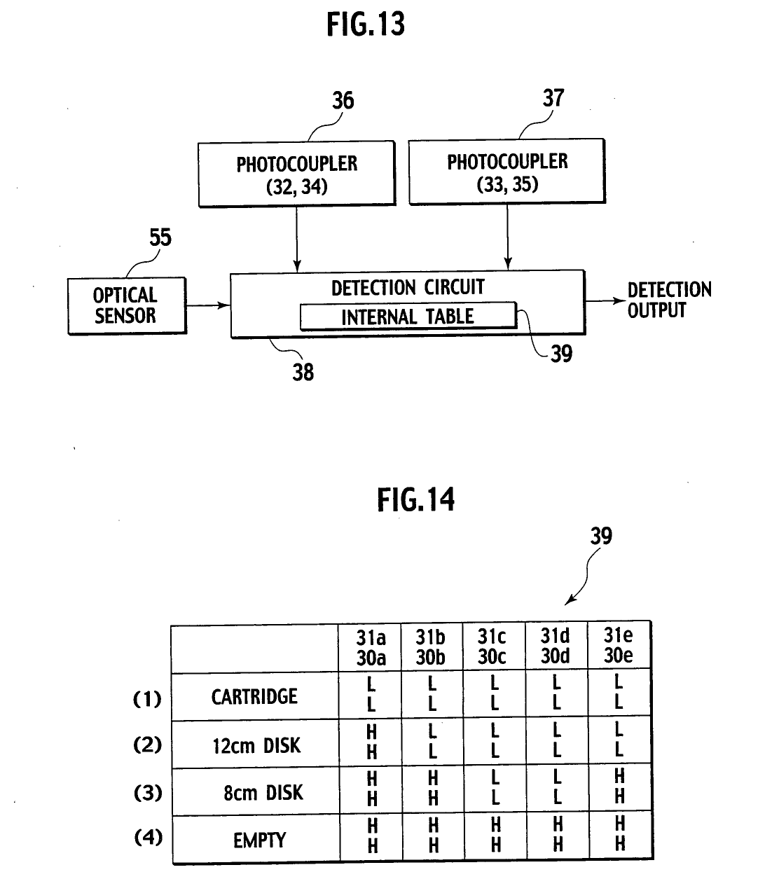

Therefore, the light emitting diode 32 and the light receiving diode 34 constitute a first photo-coupler (optical-path generating member) 36, and the light emitting diode 33 and the light receiving diode 35 constitute a second photo-coupler (optical-path generating member) 37 (see FIG. 13).

As the tray 20 is moved, an optical path generated by the first photo-coupler 36 is shielded when the detection holes 30a, 30b, 30c, 30d and 30e aligned on the straight line L1 are closed, and at this time, an output of the light receiving diode 34 becomes “L” (Low) level. On the other hand, when the detection holes are opened, they transmit light therethrough, and at this time, an output of the light receiving diode 34 becomes “H” (High) level.

Likewise, as the tray 20 is moved, an optical path generated by the second photo-coupler 37 is shielded when the detection holes 31a, 31b, 31c, 31d and 31e aligned on the straight line L2 are closed, and at this time, an output of the light receiving diode 35 becomes “L” (Low) level. On the other hand, when the detection holes are opened, they transmit light therethrough, and at this time, an output of the light receiving diode 35 becomes “H” (High) level.

The first and second photo-couplers 36 and 37 are connected to a detection circuit 38 that detects a state including a type of a medium, based on outputs of the light receiving diodes 34 and 35.

As shown in FIG. 13, the first and second photo-couplers 36 and 37 are connected to the detection circuit 38 to input thereinto outputs of the light receiving diode 34 and 35, and the optical sensor 55 is connected to the detection circuit 38 to input thereinto a pulsed output.

The detection circuit 38 includes a counter that counts a pulsed output obtained by using the optical sensor 55 to detect light passing through the slit of the ladder portion 53 provided on the left slide cam 50, and the detection circuit 38 functions as an encoder for confirmation of a position of the moving slide cam 50. Therefore, the detection circuit 38 can accurately recognize the present positions of the slide cam 50 and the tray 20 in their region of movement in real time.

In addition, when the loading motor is driven to load the tray 20 into the disc loading device 40, the detection circuit 38 monitors output levels of the light receiving diode 34 to be able to recognize an opened or closed state of the detection holes 30a, 30b, 30c, 30d and 30e, and likewise monitors output levels of the light receiving diode 35 to be able to recognize an opened or closed state of the detection holes 31a, 31b, 31c, 31d and 31e.

The detection circuit 38 also includes, as an internal table 39, data of patterns (shield patterns of optical paths), in which the detection holes 30a, 31a, 30b, 31b, 30c, 31c, 30d, 31d, 30e and 31e are opened and closed in a process of loading movement of the tray 20.

That is, when the cartridge 1 is placed in a predetermined position on the cartridge-placing surface 21 of the tray 20 to be loaded, all the detection holes 30a, 31a, 30b, 31b, 30c, 31c, 30d, 31d, 30e and 31e are closed by the cartridge 1 as shown in FIG. 10, so that data of shield patterns are as indicated in (1) of the internal table 39 shown in FIG. 14.

When a large-diameter disc (12-cm disc) 2 is placed in a predetermined position on the large-diameter disc-placing surface 22 of the tray 20 to be loaded, only the detection holes 30a and 31a are opened and the remaining detection holes 30b, 31b, 30c, 31c, 30d, 31d, 30e and 31e are closed by the large-diameter disc (12-cm disc) 2 as shown in FIG. 11, so that data of shield patterns are as indicated in (2) of the internal table 39 shown in FIG. 14.

When a small-diameter disc (8-cm disc) 3 is placed in a predetermined position on the small-diameter disc-placing surface 23 of the tray 20 to be loaded, the detection holes 30a, 31a, 30b, 31b, 30e and 31e are opened and the remaining detection holes 30c, 31c, 30d and 31d are closed by the small-diameter disc (8-cm disc) 3 as shown in FIG. 12, so that data of shield patterns are as indicated in (3) of the internal table 39 shown in FIG. 14.

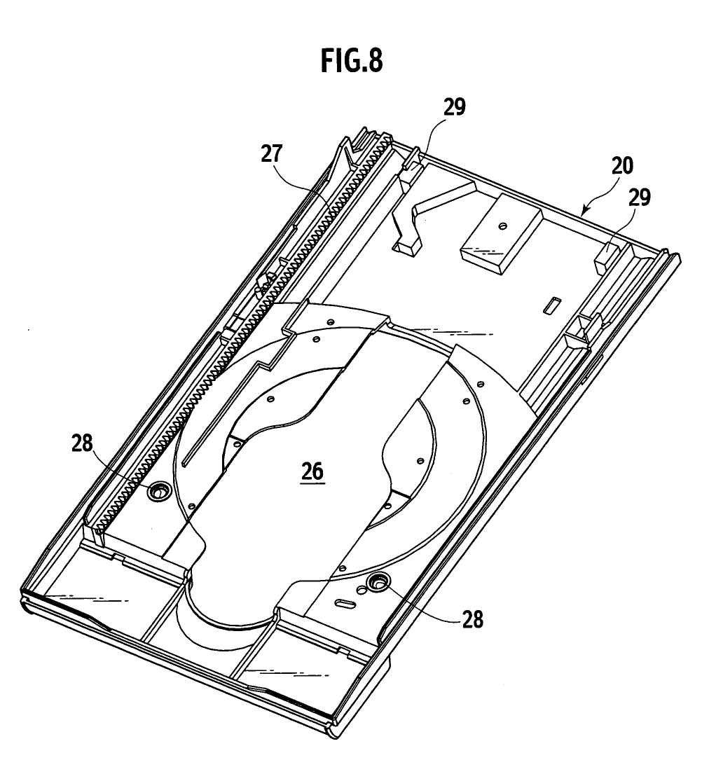

When nothing is placed on the tray 20 and the empty tray is loaded, all the detection holes 30a, 31a, 30b, 31b, 30c, 31c, 30d, 31d, 30e and 31e are opened as shown in FIG. 9, so that data of shield patterns are as indicated in (4) of the internal table 39 shown in FIG. 14.

Accordingly, when the loading motor is driven to load the tray 20 into the disc loading device 40, the detection circuit 38 temporarily stores, in a memory, those data of shield patterns of the detection holes 30a, 31a, 30b, 31b, 30c, 31c, 30d, 31d, 30e and 31e, which are obtained by monitoring output levels of the light receiving diodes 34 and 35. Then, the detection circuit 38 can detect which of the cartridge 1, the large-diameter disc (12-cm disc) 2, and the small-diameter disc (8-cm disc) 3 corresponds to a medium placed on the tray 20, by making a comparison between the temporarily stored data of shield patterns and the reference data of shield patterns in the internal table 39 shown in FIG. 14.

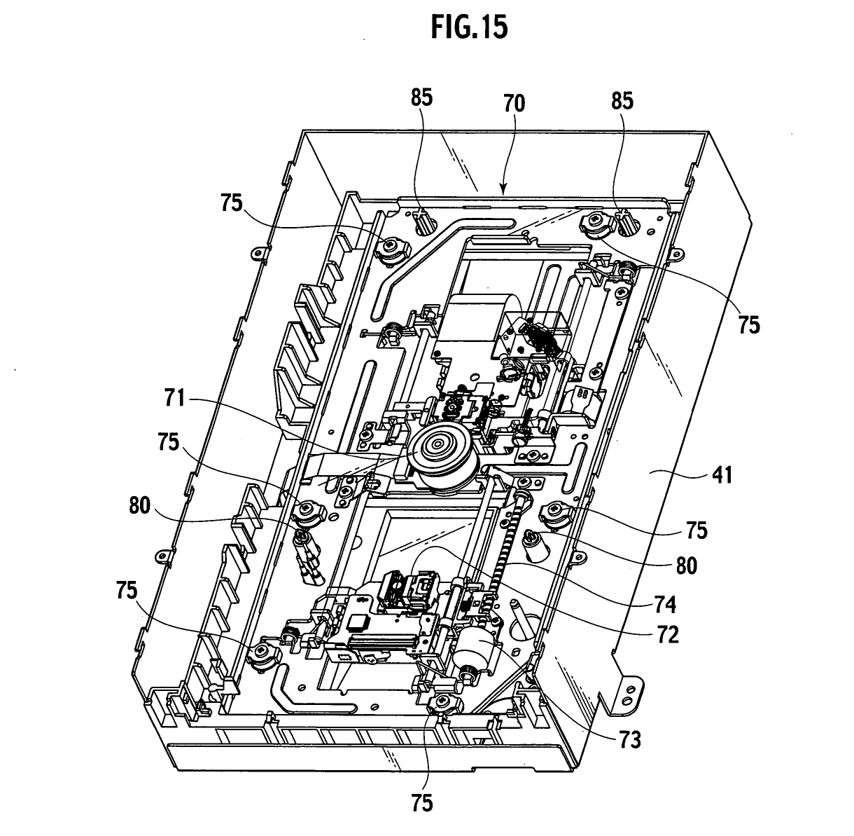

FIG. 15 is a perspective view of a traverse base 70 disposed on a bottom of the mechanical chassis 41. A spindle motor 71 which holds and rotates a bare disc or a disc accommodated in the cartridge 1, a light pickup 72 which writes and reads information in and from the disc, a traverse motor 73 which moves the light pickup 72 in a radial direction of the disc, and a lead screw 74 are mounted on the traverse base 70.

The traverse base 70 is resiliently held against the mechanical chassis 41 by means of six rubber dumpers 75. Since the traverse base 70 is resiliently supported by the rubber dumpers 75, when vibration or impact is given to the disc loading apparatus 10 from outside, influence on a recording and reproducing operation of a disc is reduced.

Alignment pins 80 and 80 are disposed on a bottom front side of the mechanical chassis 41 substantially laterally symmetrically, and projections 85 and 85 are disposed on the bottom deep side of the mechanical chassis 41 substantially laterally symmetrically. The alignment pins 80 and 80 and the projections 85 and 85 penetrate the traverse base 70 and project to a location above the traverse base 70.

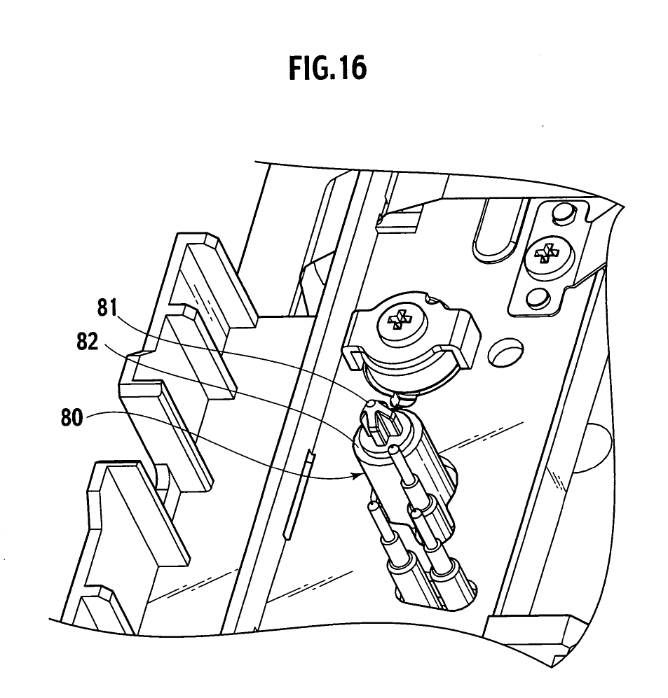

As shown in FIG. 16, the two alignment pins 80 and 80 are located in the vertical direction. That is, the alignment pin 80 is formed at its tip end with a cartridge positioning portion 81 which engages with a positioning hole (not shown) A tray positioning portion 82 which engages with positioning holes 28 and 28 of the tray 20 are formed below the cartridge positioning portion 81.

When the tray 20 is lowered as a tray holder 60 is lowered, the alignment pins 80 and 80 position the cartridge 1 placed on a cartridge placing surface 21 of the tray 20, and position the tray 20.

FIG. 18 is a block diagram of a control circuit 90 showing an electric configuration of the disc loading apparatus 10.

A laser drive circuit 91 is operated and a control circuit 90 radiates the discs 2 and 3 with laser beam from a light pickup (optical head) 72. The control circuit 90 receives signals of the discs 2 and 3 from a receiving unit of the light pickup (optical head) 72, and processes the light-reception signal in a reproduced signal processing circuit 92.

An MPU (microprocessor unit) 93 controls operations of these laser drive circuit 91, the light pickup (optical head) 72 and the reproduced signal processing circuit 92 using a RAM 94 and a modulator-demodulator circuit 95.

A temperature sensor 96 is incorporated in the light pickup (optical head) 72 for measuring the temperature in the vicinity of recording films of the discs 2 and 3.

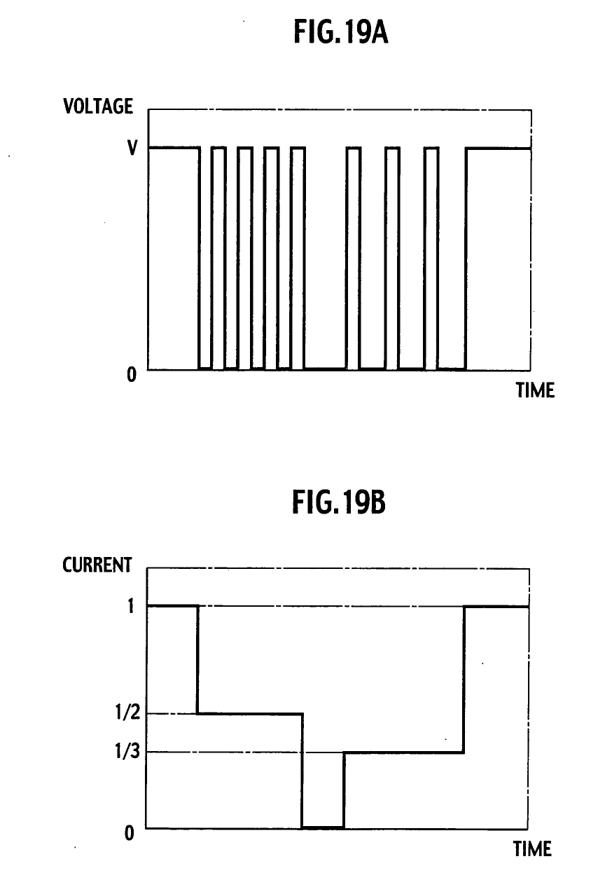

The control circuit 90 includes a PWM (Pulse Width Modulation) drive circuit 98 which drives a loading motor 97. The PWM drive circuit 98 supplies constant voltage in a form of pulse as shown in FIG. 19A for example, and changes the supply width of the pulse, the PWM drive circuit 98 can supply current corresponding to integration of supply pulse to the loading motor 97 in accordance with the supply width as shown in FIG. 19B.

The PWM drive circuit 98 can minutely set drive current of the loading motor 97. Thus, if a profile of current supply is set in a firmware, it becomes unnecessary to change the circuit constant and the drive mechanism, and it is possible to reduce the operation noises and to enhance reliability of the mechanism.

If the loading profile of the tray 20 by the loading motor 97 which is set using the PWM drive circuit 98 is set in accordance with the pulse output of the optical sensor 55, control in accordance with a position in the region of movement of the tray 20 can be performed.

An operation of the disc loading apparatus 10 configured in the above manner will be described as follows.

When any one of the cartridge 1, the large-diameter disc (12-cm disc) 2, and the small-diameter disc (8-cm disc) 3 is placed and an insertion force is applied to the tray 20 in a state that the tray 20 is ejected and drawn out from the disc loading device (drive body) 40, an operation of loading the tray 20 in the disc loading device 40 is manually started.

In the course of the manual loading operation, an eject end switch (not shown) of the tray 20 detects passage of the tray and a signal thereof turns ON the power of the loading motor 97. Thereby, the drive gear begins rotation to start movement of the tray 20 in a loading direction, and the pinion gear begins rotation to start movement of the slide cam 50.

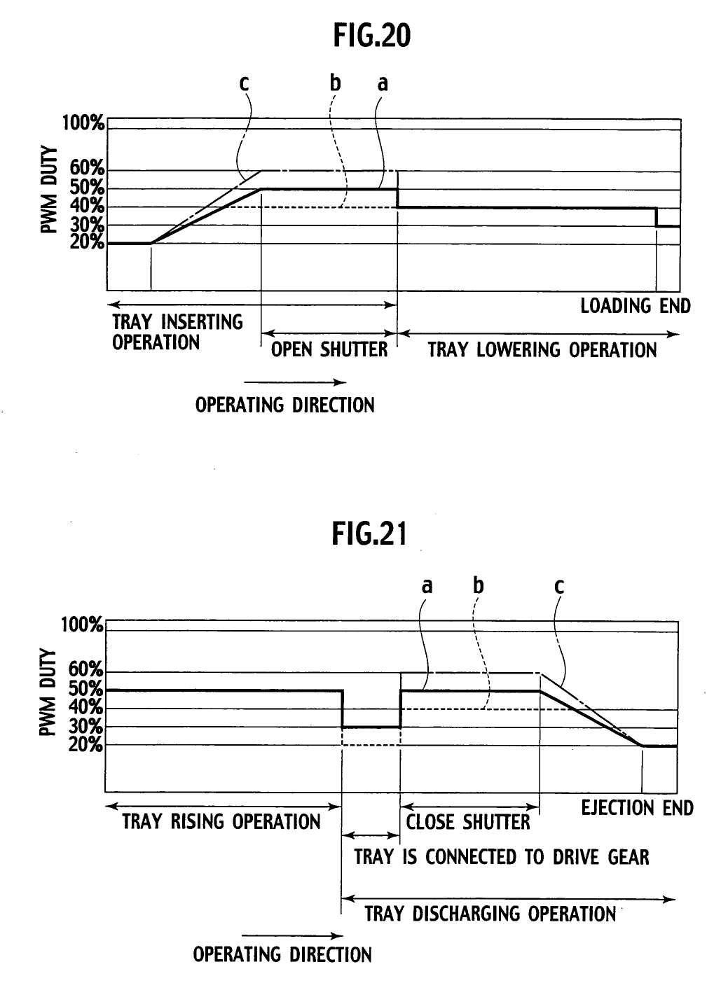

The initial loading profile is set to a value as indicated by (a) in FIG. 20 with the cartridge 1 in mind.

That is, to keep the operation integrity of the tray 20, duty is gradually increased first, and since the load is largest at a position where the shutter of the cartridge 1 is opened, the duty is set to a value suitable for the load.

The duty is reduced immediately before the loading end to prevent sudden stop. The loading operation is carried out in accordance with this profile.

The tray 20 is fitted to the tray holder 60 to eliminate backlash, and excessive load is not applied. Thus, the tray 20 can smoothly move along the tray holder 60 during the loading operation.

At this time, both the optical path of the first photo-coupler 36 composed of the light emitting diode 32 and the light receiving diode 34 and the optical path of the second photo-coupler 37 composed of the light emitting diode 33 and the light receiving diode 35 are shielded by the tray 20, so that outputs of the light receiving diodes 34 and 35 are kept at “L” level.

In a process thus started, in which the tray 20 is moved in the loading direction, the detection circuit 38 counts pulsed outputs of the optical sensor 55 to accurately recognize the present position of the tray 20 in the region of movement in real time.

Further, as the tray 20 is moved in the loading direction, the detection circuit 38 monitors respective output levels of the light receiving diodes 34 and 35 when the detection holes 30a and 31a, the detection holes 30b and 31b, the detection holes 30c and 31c, the detection holes 30d and 31d, and the detection holes 30e and 31e come to positions of the photo-couplers 36 and 37 by turns, thus obtaining data of shield patterns.

By making a comparison between the data of shield patterns thus obtained and the reference data of shield patterns shown in FIG. 14, the detection circuit 38 can detect which of the cartridge 1, the large-diameter disc (12-cm disc) 2, and the small-diameter disc (8-cm disc) 3 corresponds to a medium placed on the tray 20.

The drive gear is disengaged from a front end of the rack gear 27 immediately before the tray 20 reaches a horizontal end of the loading path, and the driving operation of the tray 20 by the loading motor 97 is stopped, but the slide cams 50 and 51 are successively moved horizontally by the loading motor 97 through the pinion gear.

If the slide cams 50 and 51 move and the tray 20 reaches the horizontal end of the loading path, the projection of the tray holder 60 moves along a downwardly inclining portion of the operation cams 52 of the slide cams 50 and 51 and the projection is lowered vertically.

As the tray 20 is lowered, the cartridge positioning portion 81 centers the positioning holes 28 and 28 of the tray 20, and the alignment pins 80 and 80 roughly position the traverse base 70 and the cartridge 1 placed on the tray 20.

As the tray 20 is lowered, the cartridge positioning portions 81 of the alignment pins 80 and 80 are engaged with positioning holes (not shown) of the cartridge 1, and the cartridge 1 is fixed to a predetermined position.

As the tray 20 is lowered, the tray positioning portions 82 of the alignment pins 80 and 80 are engaged with the positioning holes 28 and 28 of the tray 20, and engaging portions 29 and 29 of the tray 20 are engaged with and supported by the projections 85 and 85, and the tray 20 is fixed to a predetermined position.

Accordingly, the positioning operations of the cartridge 1 and the tray 20 are completed. A projection of the tray holder 60 and a projection of a clamp arm 62 are biased against the mechanical chassis 41 by torsion springs (not shown) provided on the slide cams 50 and 51, thereby limiting vibration generated in the tray 20 and the cartridge 1.

With the above procedure, the loading operation of the cartridge 1 placed on the tray 20 to the disc loading apparatus 10 is completed.

An ejecting operation of the cartridge 1 is the reverse of the loading operation. The initial ejecting profile is set to a value as indicated by (a) in FIG. 21 with the cartridge 1 in mind.

That is, the duty is first set to release the clamp of the disc, and the duty is reduced at a position where the tray 20 moves horizontally and is connected to the drive gear because noises are generated.

Since a load is largest at a position where the shutter of the cartridge 1 is closed, the duty is set suitably for the state.

To keep the operation integrity of the tray 20, the duty is gradually reduced up to the eject end to prevent the sudden stop. The ejecting operation is carried out in accordance with this profile.

When no cartridge 1 is placed on the tray 20, there is no load for opening and closing the shutter of the cartridge 1, so that the profile is changed in accordance with the state.

When the detection circuit 38 determines that cartridge 1 is not placed on the tray 20, the loading profile is changed to a profile as indicated by (b) in FIG. 20. In this case, since there is no opening and closing operation of the shutter, the duty is reduced as compared with a value used when there is a cartridge 1 at that position. With this, it is possible to prevent operation noises and the speed from being increased.

The ejecting profile is also changed to the one as indicated by (b) in FIG. 21. In this case, since there is no opening and closing operation of the shutter, the duty is reduced as compared with a value used when there is a cartridge 1 at that position. Accordingly, it is possible to prevent operation noises and the speed from being increased.

Generally, it is preferable that the loading noise is smaller. The gear ratio of the loading mechanism and the firm specification are set with the standard disc in mind, but when an abnormal disc is used or when the temperature is low, torque becomes insufficient, and there is an inconvenience that the disc cannot be carried.

If the firmware specification is changed by the loading and ejecting operations at the ensured temperature, as well as at a low temperature other than the ensured temperature (lower than 5° C., for example), at which a load of the loading mechanism becomes large due to the temperature environment, the above inconvenience can be overcome. The switching temperature is measured using a temperature sensor 96 of the light pickup 72.

The temperature is detected before the loading and ejecting operation is carried out, and a previously prepared profile (duty is increased when the load is large) as indicated by (c)s in FIGS. 20 and 21 is applied.

Normally, the loading and ejecting operation is completed in accordance with the profile, but it is conceived that the operation is stopped halfway through the operation due to unexpected happenings, such as when a cartridge used is out of standard or a finger is caught in the tray. In this case, depending upon the position of the unexpected happening, there are cases that the duty should be increased to move the tray in the normal direction, and that the tray should be moved in the opposite direction.

Thereupon, this problem can be solved by monitoring the pulse output of the optical sensor 55 and by measuring the time.

When it is determined that the operation is stopped, if the pulse output of the optical sensor 55 is not changed for 300 ms or longer, the operation mode is shifted to a fail-safe operation mode.

If there is a possibility that a finger is caught in the tray 20, the reverse rotation is carried out immediately. If the shutter of the cartridge 1 is opened or closed at that position, the duty is increased, and if nothing is changed, the reverse rotation is carried out.

The setting of the loading profile (including the reverse rotation) and the setting of the ejecting profile (including the reverse rotation) are carried out under the control of the MPU (drive profile control unit) 93 using the RAM 94.

It is not always necessary that a slit 53 for detecting the position provided on the slide cam 50 is continuously formed over the entire region of movement of the slide cam 50, and the slit 53 may be formed at necessary position in accordance with the required precision.

According to the disc loading apparatus 10 of the present invention as configured above, since the disc loading apparatus 10 is controlled in accordance with positions of the tray 20 and the slide cam 50, noises can be reduced, and the operation integrity can be ensured.

By detecting the type of a medium, in a case of the cartridge 1, for example, the driving torque is increased when a load is large such as when the shutter is opened or closed, and a sense of disharmony caused by a speed difference generated depending upon different type of a medium or based on whether a medium is placed on the tray can be overcome.

In addition, variations in loading time and ejecting time caused by temperature variations can be reduced.

Furthermore, when a trouble, such as the cartridge 1 being erroneously placed, occurs and the tray 20 is stopped halfway through the loading or ejecting operation, the operation mode can be shifted to the fail-safe operation mode within a short time, user's anxiousness can be overcome, and a fail-safe operation can be carried out in accordance with a position of a movable portion.

The disc loading apparatus according to the present invention includes a disc loading device, into or from which a placing member with a disc-like medium placed thereon is loaded or ejected by a drive unit, a position detection unit which optically detects a position of a region of movement of the placing member concerning at least a portion of a loading path with a loading operation of the placing member, and a drive profile control unit which changes a drive profile of the drive unit based on a position detection signal from the position detection unit. Therefore, the driving state in the loading path can be controlled in accordance with the loading operation of the placing member on which the disc-like medium is placed. Thus, there is an effect that noises can be prevented from being generated by reducing the loading speed at a position where a noise in the loading path is large.

The entire contents of Japanese Patent Application P2004-137106 (filed May 5, 2004) is incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined in the following claims.

1. A disc loading apparatus comprising:
a disc loading device, into or from which a placing member with a disc-like medium placed thereon is loaded or ejected by a drive unit;
a position detection unit which optically detects a position of a region of movement of the placing member concerning at least a portion of a loading path with a loading operation of the placing member; and
a drive profile control unit which changes a drive profile of the drive unit based on a position detection signal from the position detection unit.

2. A disc loading apparatus comprising:
a disc loading device, into or from which a placing member on which a cartridge accommodating a disc-like medium therein is placed is loaded or ejected by a drive unit;
a position detection unit which optically detects a position of a region of movement of the placing member concerning at least a portion of a loading path with a loading operation of the placing member; and
a drive profile control unit which changes a drive profile of the drive unit based on a position detection signal from the position detection unit.

3. The disc loading apparatus according to claim 2, further comprising a medium type detection unit which optically detects types of a medium placed on the placing member based on whether a detection hole for detecting a medium provided on the placing member is shielded at the time of a loading operation of the placing member, wherein
the drive profile control unit changes the drive profile based on a position detection signal from the position detection unit and a medium type detecting signal from the medium type detection unit.

4. The disc loading apparatus according to claim 1, further comprising a temperature measuring unit which measures temperature in the disc loading device, wherein
the drive profile control unit changes the drive profile based on temperature measured by the temperature measuring unit.

5. The disc loading apparatus according to claim 2, further comprising a temperature measuring unit which measures temperature in the disc loading device, wherein
the drive profile control unit changes the drive profile based on temperature measured by the temperature measuring unit.

6. The disc loading apparatus according to claim 3, further comprising a temperature measuring unit which measures temperature in the disc loading device, wherein
the drive profile control unit changes the drive profile based on temperature measured by the temperature measuring unit.

7. The disc loading apparatus according to claim 1, wherein the drive profile control unit monitors a generation state of a position detection signal from the position detection unit, and changes the drive profile when abnormality of the position detection signal is generated.

8. The disc loading apparatus according to claim 2, wherein the drive profile control unit monitors a generation state of a position detection signal from the position detection unit, and changes the drive profile when abnormality of the position detection signal is generated.

9. The disc loading apparatus according to claim 3, wherein the drive profile control unit monitors a generation state of a position detection signal from the position detection unit, and changes the drive profile when abnormality of the position detection signal is generated.
